(19) United States
(12) Patent Application Publication
(10) Pub. No.: US 2009/0150664 A1
(43) Pub. Date: Jun. 11, 2009

(54) COMPUTER MANAGEMENT SYSTEM

(75) Inventors: Stephen Zhang, Taipei (TW); Elise Kun Tan, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/951,477

(22) Filed: Dec. 6, 2007

(51) Int. Cl. H04L 9/00

(52) U.S. Cl. 713/153

(57) ABSTRACT

A computer management system is provided. In addition to a console and a computer, the computer management system comprises an encryption device and a decryption device. The console outputs a control signal. The encryption device encrypts the control signal to output an encryption signal. The decryption device then decrypts the encryption signal into the control signal, such that the computer is controller.

### BACKGROUND OF THE INVENTION

1. Field of the Invention

The invention relates to Keyboard-Video-Mouse (KVM) systems, and in particular, to mechanisms for control signal encryptions in KVM systems.

2. Description of the Related Art

Conventionally, a Keyboard-Video-Mouse (KVM) switch is used to control a plurality of computers via only one set of keyboard, video and mouse. A console is an integrated interface of the keyboard, video and mouse, coupled to the KVM switch for control of the computers. The console can be directly coupled to the KVM switch through a local end, or remotely control computers using a combination of serially coupled KVM switches and extenders.

When long distance connection to a console is required, security issues become a serious concern. Since the control signals of a keyboard and mouse sent from the console are unencrypted, they can be easily intercepted and compromised. Confidential information such as username and password may be thereby exposed. Therefore, an enhancement is desirable.

### BRIEF SUMMARY OF THE INVENTION

An embodiment of a computer management system is provided. In addition to a console and a computer, the computer management system comprises an encryption device and a decryption device. The console outputs a control signal. The encryption device encrypts the control signal to output an encryption signal. The decryption device then decrypts the encryption signal into the control signal, such that the computer is controlled by the console according to the control signal sent from the decryption device.

Furthermore, at least one KVM switch is connected between the encryption device and the decryption device. The encryption and decryption devices may be connected to the KVM switch via CAT 5 cable. The encryption and decryption devices may form a set of extenders. Alternatively, the encryption device and the decryption devices may be a pair of KVM switches.

In another embodiment of a computer management system, a first KVM switch encrypts a control signal into an encryption signal, and a second KVM switch decrypts the encryption signal into the control signal. CAT 5 cables may be used for connections between the first dongle to the second KVM switch, the second dongle to the second KVM switch, and the second dongle to the second KVM switch.

In the embodiment, a console may output a first control signal. A first dongle is connected between the console and the first KVM switch to receive the first control signal and output the control signal to the first KVM switch. A second dongle receives the control signal and outputs a second control signal. The computer is therefore controlled by the second control signal.

Alternatively, the console may output the control signal to the first KVM switch, and the dongle receives the control signal to generate a first control signal. Then the computer is controlled by the first control signal.

Alternatively, the console may output a first control signal, and the dongle connected between the console and the first KVM switch receives the first control signal and generates the control signal to the first KVM switch. The computer is thereby controlled.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an embodiment of a computer management system according to the invention; and

FIG. 2 shows another embodiment of computer management system according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

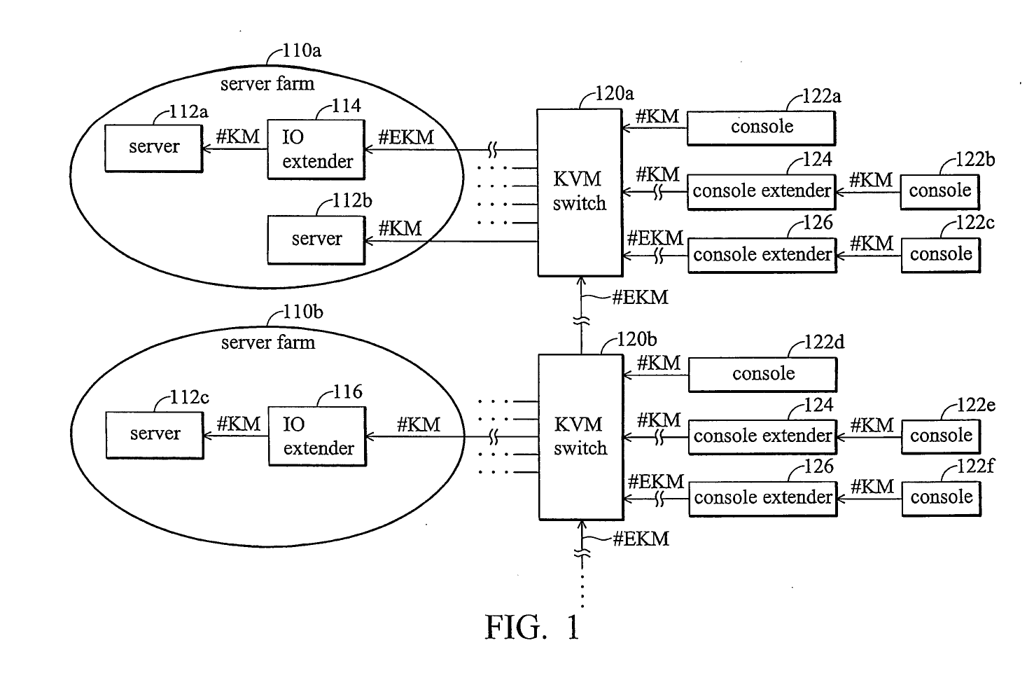

FIG. 1 shows an embodiment of a computer management system according to the invention. When there are a large number of servers to be controlled centrally, for management purpose, server farms (110a and 110b) are formed, and a topology can be constructed by serial connections of various extenders (IO extender 114, IO extender 116, 124, console extender 126) and KVM switches (120a, 120b) to transmit the control signals control signal #KM. In the embodiment, a secured architecture is provided to send the control signals confidentially. Specifically, encryption and decryption technologies are implemented in the computer management system such that encrypted control signals #EKM are transmitted along the distance cables.

Generally, a console 122 (122a to 122f) generates a control signal #KM comprising keyboard and mouse signals which are not encrypted, and a server 112 (112a to 112c) is controlled accordingly. An encryption mechanism is required before sending the control signal #KM into a distant cable, and a decryption mechanism is required, such that the encrypted control signals #EKM is decrypted into control signal #KM before the servers receive it. Based on this concept, various examples are introduced hereafter.

In one embodiment, a server 112a is coupled to a KVM switch 120a through an IO extender 114. The KVM switch 120a sends encrypted control signal #EKM to the IO extender 114, and the IO extender 114 decrypts the encrypted control signal #EKM into control signal #KM and transmits it to the server 112a. If a server 112b is directly coupled to the KVM switch 120a, the decryption mechanism may also be implemented in the KVM switch 120a to provide the control signal #KM from encrypted control signal #EKM input from somewhere else. Alternatively, if a server 112c is coupled to a KVM switch 120b through an IO extender 116, and the KVM switch 120b sends a control signal #KM decrypted from somewhere else, the IO extender 116 directly transmits the control signal #KM to the server 112c without further processing.

Meanwhile, the source of the control signal #KM sent to the servers 112a, 112b or 112c, may originate from one of the consoles 122a to 122f. In one embodiment, a console 122a originates the control signal #KM to the KVM switch 120a, and the KVM switch 120a may comprise an encryption mechanism to encrypt the control signal #KM into encrypted control signal #EKM. The encrypted control signal #EKM may then be sent to the IO extender 114, or the server 112 through another KVM switch 120b and an IO extender 116. In these cases, decryption of the encrypted control signal #EKM is performed in the IO extender 114 or the KVM switch 120b.

Additionally, a console 122b may be coupled to the KVM switch 120a through a console extender 124. The control signal #KM is transmitted through the console extender 124 and encrypted in the KVM switch 120a. The encrypted control signal #EKM is then sent to the IO extender 114 or the KVM switch 120b for decryption, thus the server 112a or the server 112c is controlled.

In a further embodiment, a console 122c is coupled to the KVM switch 120a through a console extender 126. The encryption mechanism is implemented in the console extender 126 to convert the control signal #KM into encrypted control signal #EKM. Thus, the KVM switch 120a simply transmits the encrypted control signal #EKM to the IO extender 114 or the KVM switch 120b for further decryption.

In the KVM switch 120b, a control signal #KM may be provided from a console 122d destined to the server 112a. In this case, the KVM switch 120b encrypts the control signal #KM and transmits encrypted control signal #EKM to the KVM switch 120a. As described, the KVM switch 120a may perform the decryption and transmit the control signal #KM to control the server 112b. The decryption may also be performed in the IO extender 114 for control of the server 112a.

If a console 122e is intended to control the server 112a, a console extender 124 may be used to transmit the control signal #KM to the KVM switch 120b, and the KVM switch 120b would encrypt the control signal #KM to output encrypted control signal #EKM which is then transmitted through KVM switch 120a to the IO extender 114. The IO extender 114 then decrypts the encrypted control signal #EKM into control signal #KM to control the server 112a. Alternatively, if the encrypted control signal #EKM is destined to control the server 112b which is directly connected to the KVM switch 120a, the decryption of encrypted control signal #EKM can also be performed in the KVM switch 120a.

If the control signal #KM is originated from the console 122f destined to control the server 112a or 112b, a console extender 126 may provide the encryption mechanism to generate encrypted control signal #EKM. The KVM switch 120b would simply transmit the encrypted control signal #EKM to the KVM switch 120a, and the KVM switch 120a would transmit the encrypted control signal #EKM to an IO extender 114 for decryption, or decrypt the encrypted control signal #EKM by itself for a directly connected server 112b.

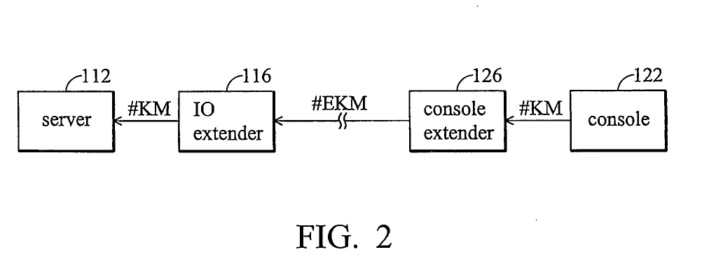

FIG. 2 shows another embodiment of computer management system according to the invention. In the embodiment, no KVM switches are used, only an IO extender 116 and a console extender 126 are used to extend the distance between the server 112 and console 122. To secure the control signal #KM along the distant cable, an encryption mechanism is implemented in the console extender 126, and a decryption mechanism is deployed on the IO extender 116.

It is shown that the secured computer management can be adapted in various topologies. The algorithms of encryption and decryption can be symmetric key algorithms such as DES or AES, or asymmetric key algorithms such as RSA or DSA. For example, a set of password may first be input in the encryption end and the decryption end, such that a secure channel is simply established.

In certain conditions, the control signal #KM is not limited to be encrypted and decrypted one time. For example, a first key may be shared by the KVM switches 120a and 120b to secure the connection therebetween. When a console 122f issues a control signal #KM destined to a server 112a, the console extender 126 and IO extender 114 may share a second key to encrypt and decrypt the control signal #KM. In this way, the control signal #KM is first encrypted in the console extender 126 by a second key, and then encrypted by the KVM switch 120b using a first key. Thereafter, the KVM switch 120a decrypts what is received from the KVM switch 120b by the first key, and transmits the decryption result, the encrypted control signal #EKM to the IO extender 114. Then, the IO extender 114 decrypts the encrypted control signal #EKM by the second key to reacquire the control signal #KM, such that the server 112a is controlled.

As described, decryption mechanisms are deployed in IO extender 114 and IO extender 116, whereas encryption mechanisms can be deployed in console extender 124 and console extender 126. The KVM switches 120a and 120b are capable of encrypting and decrypting control signal #KM when required. The IO extenders 114 and 116, console extenders 124 and 126, also referred to as dongles, connect to the KVM switches via CAT 5 cable. Any topology using the dongles and the KVM switches can be adapted in the invention, and the number of dongles and KVM switches is not limited to the embodiments described in FIGS. 1 and 2. In one embodiment, the IO extender and the console extender may be dongles. The console may include a keyboard and/or a mouse. The control signal outputted from the console includes a keyboard control signal and/or a mouse control signal. The control signal may be firstly encrypted in an encryption device and finally be decrypted in a decryption device disposed between the console and the computer. The encryption device may be console dongle, KVM switch or extender. The decryption device may be computer dongle, KVM switch or extender.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A computer management system, comprising:
a console, outputting a control signal;
an encryption device, coupled to the console for encrypting the control signal sent from the console into an encryption signal;
a decryption device, decrypting the encryption signal into the control signal; and
a computer, coupled to the decryption device, being controlled by the console according to the control signal sent from the decryption device.

2. The computer management system of claim 1, further comprising at least one KVM switch connected between the encryption device and the decryption device.

3. The computer management system of claim 2, wherein the encryption device is connected to the KVM switch via CAT 5 cable.

4. The computer management system of claim 3, wherein the decryption device is connected to the KVM switch via CAT 5 cable.

5. The computer management system of claim 1, wherein the encryption and decryption devices are a set of extenders.

6. The computer management system of claim 1, wherein the encryption device and the decryption devices are two KVM switches.

7. The computer management system of claim 6, wherein the KVM switches are cascaded in series.

8. The computer management system of claim 6, wherein the KVM switches are daisy chained with each other.

9. A computer management system, comprising:
a first KVM switch, encrypting a first control signal into a encryption signal, and outputting the encryption signal; and
a second KVM switch, decrypting the encryption signal into a second control signal, and outputting the second control signal.

10. The computer management system of claim 9, further comprising:
a console, outputting a third control signal;
a first dongle connected to the first KVM switch, receiving the third control signal and outputting the first control signal to the first KVM switch;
a second dongle connected to the second KVM switch, receiving the second control signal and outputting the third control signal; and
a computer connected to the second dongle, being controlled by the console according to the third control signal sent from the second dongle.

11. The computer management system of claim 10, wherein the first dongle is connected to the second KVM switch via CAT 5 cable.

12. The computer management system of claim 11, wherein the second dongle is connected to the second KVM switch via CAT 5 cable.

13. The computer management system of claim 10, wherein the second dongle is connected to the second KVM switch via CAT 5 cable.

14. The computer management system of claim 10, wherein the console includes a keyboard and/or a mouse.

15. The computer management system of claim 9, further comprising:
a console, outputting the first control signal to the first KVM switch;
a dongle connected to the second KVM switch, receiving the second control signal and outputting the first control signal; and
a computer connected to the dongle, being controlled by the console according to the first control signal sent from the dongle.

16. The computer management system of claim 15, wherein the dongle is connected to the second KVM switch via CAT 5 cable.

17. The computer management system of claim 15, wherein the console includes a keyboard and/or mouse.

18. The computer management system of claim 9, further comprising:
a console, outputting the second control signal;
a dongle connected to the first KVM switch via CAT 5 cable, receiving the second control signal and outputting the first control signal to the first KVM switch;
a computer connected to the second KVM switch, being controlled by the console according to the second control signal sent from the second KVM switch.

19. The computer management system of claim 18, wherein the dongle is connected to the second KVM switch via CAT 5 cable.

20. The computer management system of claim 18, wherein the console includes a keyboard and/or a mouse.
